(19) United States
(12) Patent Application Publication
(10) Pub. No.: US 2007/0264474 A1
(43) Pub. Date: Nov. 15, 2007

(54) Component for a vehicle interior and a mold assembly and a method for assembling the component

(75) Inventors: William J. Filipp, Shelby Township, MI (US); Kevin A. Kieltyka, Rochester, MI (US); Kim Langenbacher, St. Clair Shores, MI (US); Jason L. Stone, Avoca, MI (US); Sam Koutros, Tecumseh (CA); Kevin P.J. LaPensee, Ruthven (CA)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/432,247

(22) Filed: May 11, 2006

(51) Int. Cl. B29C 45/16; B32B 1/00

(52) U.S. Cl. 428/174; 425/468; 425/130; 264/255; 264/328.8

(57) ABSTRACT

A mold assembly, a method of molding, and a molded component for an interior of a vehicle using two shots of material. The mold assembly includes first and second mold halves cooperating to define a cavity. One of the mold halves includes a retractable core. The second mold half defines a divider for engaging the retractable core, when the retractable core is extended, so as to divide the mold cavity into first and second chambers. Portions of the core cooperate to define a sloped surface on the first shot that aids in inhibiting flash forming as the second shot is introduced into the mold assembly.

### BACKGROUND

1. Field of the Invention

The present invention relates generally to a mold assembly and method for molding a two-shot component for use as a trim assembly in a passenger compartment of a motor vehicle.

2. Related Technology

Vehicle interiors, such as door panels, instrument panels, and the like often include a component made of a thermoplastic material. Occasionally, for aesthetic purposes, it is desirable for the component, or more specifically for a portion of the component that is exposed to the vehicle occupants (commonly known as the “A” or “show” surface have two or more differently-colored sections. Additionally, or alternatively, it may be desirable for the component to have two or more sections with different textures or patterns so that the component has a bi-textured feel.

One current way at achieving a bi-colored component includes painting a first area a first color and painting a second area another color. In an alternative construction, only the first area is painted and the remaining area remains its natural color. Another construction for a bi-colored component includes manufacturing a component through a powder slush process. More specifically, a portion of a mold inner surface is coated with a powder having a first color and the remaining portion of the mold inner surface is coated with a powder having a second color. The mold is then heated, sintering the first and second powders and bond them together to form the component.

The above constructions, however, may result in an undesirably irregular or non-continuous border between the differently colored areas. Moreover, painted areas of the show surface may be more prone (than non-painted areas) to premature color fading and/or paint chipping or cracking. Furthermore, it may not be possible to produce a component having a bi-textured skin through painting alone.

Yet another known bi-colored construction uses a two-shot molding process. A first shot of molten material is injected into a first chamber to form a first skin component and a second shot of molten material is injected into a second chamber to form a second skin component. This can occur in a single mold, if a retracting core is slidably positioned within the mold assembly for selectively separating and connecting the respective chambers. For Example, the first shot is delivered to the mold when the retractable core is in a closed position. As a result, the material is only able to flow into a first chamber of the mold cavity. Upon retraction of the core into an open position, a second shot of material is able to flow throughout the remainder of the mold cavity.

One limitation of the above is that, when the core is retracted, the first shot of material is no longer restrained against the mold surface and may be susceptible to flashing. More specifically, flashing occurs when the first shot is able to move away from the mold and the second shot flows between the first shot and the mold surface, thereby contaminating the show surface of the component with extra, undesirable material and/or misaligning the respective portions of the component with respect to each other.

Obviously, it would be advantageous to provide a component having a structure that resists flashing and to provide a mold assembly and method that substantially reduce flashing.

### SUMMARY

In overcoming the limitations and drawbacks of the prior art, the present invention provides a mold assembly for assembling a component, a method for assembling a component, and a component for an interior of a vehicle.

In one aspect of the present invention, a mold assembly includes a first mold half having a receiving slot, a second mold half cooperating with the first mold half to define a mold cavity, and a retractable core positioned within the receiving slot so as to be slidable between a retracted position and an extended position. The second mold half defines a divider extending towards the receiving slot and engaging the retractable core when the retractable core is in the extended position so as to divide the mold cavity into first and second chambers. The divider therefore reduces flashing by acting as a shield for the leading edge of the first shot of material.

The retractable core includes an engagement surface that engages the divider when the retractable core is in the extended position. The retractable core also preferably defines a sloped portion sloping away from the engagement surface along a first axis and away from the second mold half along a second axis perpendicular to the first axis. The sloped portion therefore further reduces flashing by diverting the flow of the second shot of material towards the second cavity and urging the first shot of material into tight engagement with the mold surface. The sloped portion may be any suitable shape, such as linear or arcuate.

In another aspect of the present invention, a method of assembling a component for an interior of a vehicle includes the steps of positioning a retractable core in an extended position so as to engage a divider portion and divide a mold cavity into first and second chambers, injecting a first shot of material into the chamber so that the leading edge of the first shot engages the divider, moving the retractable core to a retracted position, and injecting a second shot of material into the second chamber so that the material flows between the first shot and the retractable core. The step of injecting the second shot of material preferably occurs before the first shot of material is fully hardened so as to reduce cycle time and improve bonding between the respective shots.

In yet another aspect of the present invention, a component for a motor vehicle interior includes a first skin portion and a second skin portion engaging each other. The first skin portion includes an A-surface and a B-surface intersecting along a first skin leading edge and cooperating to define a generally sloped portion. The first and second skin portions cooperate to define a show surface exposed to the motor vehicle interior and to define an indentation extending along the first skin leading edge.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a cross-sectional view of an injection molding assembly for molding a motor vehicle interior component and embodying the principles of the present invention;

FIG. 2 is an enlarged view of the injection molding assembly taken along line 2-2 in FIG. 1 having upper and lower molds defining a mold cavity and a retractable core disposed within a slot of the lower mold;

FIG. 3 is an enlarged view of the injection molding assembly seen in FIG. 2, where a first chamber of the mold cavity has been filled with a first shot of material;

FIG. 4 is an enlarged view of the injection molding assembly seen in FIG. 3, where the core has been moved to a retracted position;

FIG. 5 is an enlarged view of the injection molding assembly seen in FIG. 4, where a second chamber of the mold cavity is partially filled with a second shot of material;

FIG. 6 is an enlarged view of the injection molding assembly seen in FIG. 5, where the second chamber of the mold cavity is completely filled with the second shot of material;

FIG. 7 is an enlarged cross-sectional view of an alternative embodiment of an injection molding assembly for molding a motor vehicle interior component embodying the principles of the present invention; and

FIG. 8 is an enlarged cross-sectional view of another embodiment of an injection molding assembly for molding a motor vehicle interior component and embodying the principles of the present invention.

### DETAILED DESCRIPTION

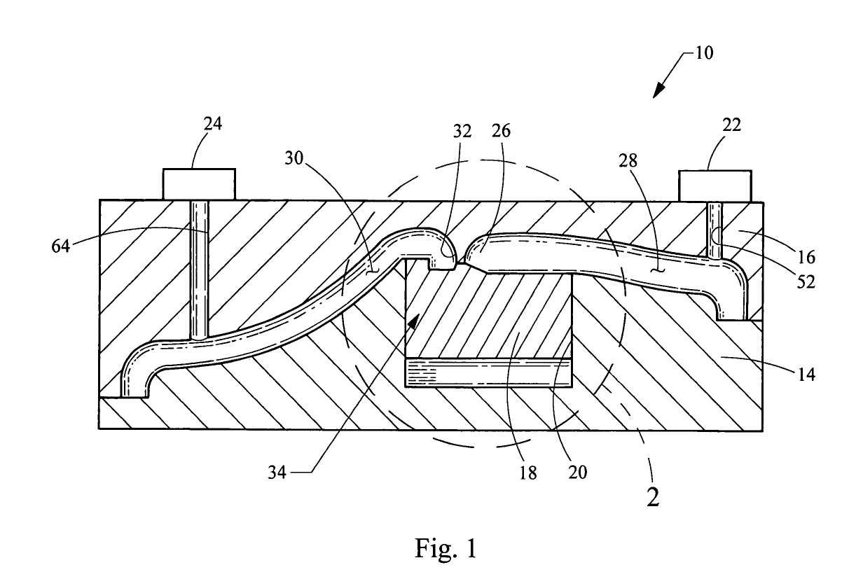

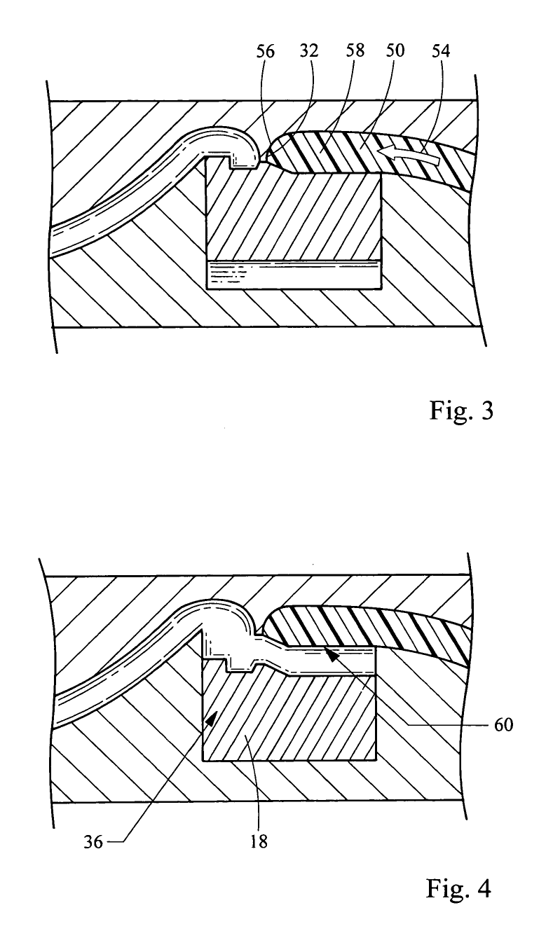

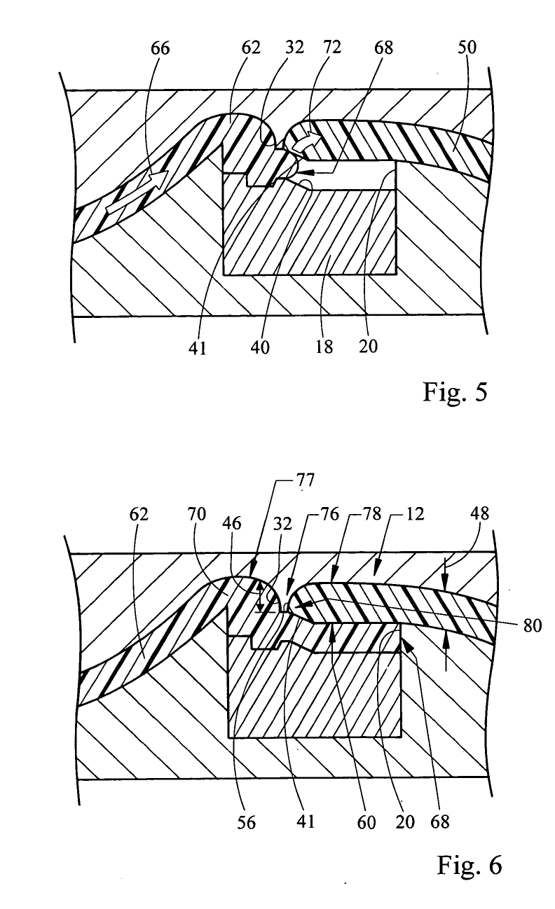

Referring now to the drawings, FIG. 1 shows an injection mold assembly 10 for molding a component 12 (FIG. 6) for the interior of a motor vehicle. The molding assembly 10 generally includes a lower mold 14, an upper mold 16, a retractable core 18 disposed within a slot 20 of the lower mold 14, and a pair of injection assemblies 22, 24 for delivering molten material. The molds 14, 16 cooperate to define a mold cavity 26 and the upper mold cooperates with the retractable core 18 to divide the cavity 26 into a first chamber 28 and a second chamber 30. More specifically, the retractable core 18 is slidable within the slot 20 between an extended position 34 (FIGS. 1, 2 and 3) and an open position 36 (FIGS. 4, 5 and 6). When the retractable core 18 is in the extended or closed position 34, an engagement surface 38 engages a divider 32 formed on the mold surface of the upper mold 16 and extending towards the slot 20. With this contact, the core 18 divides the cavity 26 into the first and second chambers 28, 30.

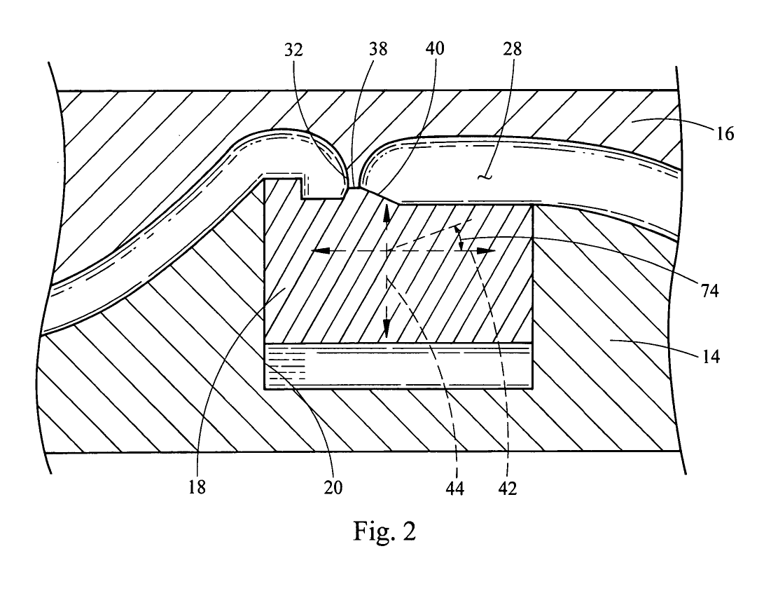

Referring to FIG. 2, the retractable core 18 is shown in more detail and includes the engagement surface 38, for contacting the divider 32, and a sloped portion 40, for causing the molten material to flow as desired. The sloped surface 40 slopes from the contact surface 38 in a direction away from the upper mold 16. As will be more fully discussed below, this surface 40 defines a design line configuration on a first shot of material injected into the first mold cavity 28. This sloped design line configuration promotes pressure on the back of the first shot during the second shot of material, effectively sealing the first shot against the mold 16 to inhibit the formation of flash along the design line. In other words, the sloped portion 40 generally defines a negative slope measured along the axes 42, 44 shown in FIG. 2 for reducing flashing.

As a result of its height, the divider 32 is able to substantially shield the molten material at the first shot located in the first chamber 28 and also aid in reducing flashing.

As shown in FIGS. 1 & 3, the first injection assembly 22 delivers a first shot 50 of molten material through a first injection port or conduit 52 and into the first chamber 28 of the cavity 26. The first shot general trails along a first shot path in the direction of arrow 54. More specifically, with the core 18 closed, the first shot 50 preferably completely fills the first chamber 28 so that the first shot 50 engages the divider 32.

The first shot 50 of molten material defines a first skin component 58 of the component 12. The first skin component 58 may be made of any suitable material, such as thermoplastic. Because it is typically visible from the vehicle interior, the first skin component 58 is preferably formed from a molten material having a desirable color so that painting and/or dyeing is unnecessary.

After the first shot 50 of molten material fills the first chamber 28 and has sufficiently cooled so as to retain its shape, the core 18 is retracted to its retracted or open position 36, as seen in FIG. 4. The retractable core 18 is preferably able to be retracted without opening the mold assembly 10. The construction of retractable cores is generally well known and, therefore, further detailed description is not provided herein

Although the retractable core 18 may be retracted to the open position 36 any time after the first shot 50 is delivered to the first chamber 28 and the first shot has cooled so as to be able to retain its shape, the retraction preferably occurs when the first shot 50 has not yet fully hardened. More specifically, the retractable core 18 is preferably retracted 10 seconds or less after the first chamber 28 has been completely filled with molten material. By retracting the core 18 shortly after the first shot 50 is delivered, the overall cycle time for the resulting component can be reduced, thereby increasing productivity and lowering manufacturing costs. Furthermore, undesirable gaps or imperfections in that portion of the component 12 defined by the first shot 50 are reduced by a relatively quick retraction of the core 18 and delivery of the second shot. More specifically, molten material shrinks as it cools and thereby can create gaps between the molding and the molds 14, 16. These gaps may promote flashing and or part misalignment during later stages of the molding process, as will be discussed further below.

As the retractable core 18 moves into the retracted position 36, the second chamber 30 is enlarged and a B-surface 60 of the first shot 50 partially defines the enlarged second chamber. As used herein, the term “B-surface” refers to a surface that is not exposed in the vehicle's interior during normal use of the vehicle. A portion of the B-surface 60 corresponding to the surface 40 of the core 18 now defines a ramped surface 61 adjacent to the design line or edge 63 of portion of the component defined by the first shot 50. This ramped surface 61 generally extends from the end of the design line 63 in such a direction that the thickness of the first shot 50 generally increases to the nominal thickness of the component.

Next, the second injection assembly 24 delivers a second shot 62 of molten material through a second injection port or conduit 64 into the enlarged second chamber 30 of the cavity 26. The second shot 62 flows along a second shot path as generally indicated by arrow 66. As the second shot 62 fills the second chamber 30, a leading edge 68 of the second shot 62 flows past the divider 32, between the first shot 50 and the retractable core 18 the divider 32 and encounters the transition surface 61 of the first shot 50. As a result of the sloped shape of this surface 61, the design line 63 and the first shot 50 are forced or pressed into the upper mold 14 by the pressure exerted by the second shot 62. The second shot 62 continues until the enlarged second chamber 30 is completely filled and the leading edge 68 of the second shot 62 engages a side wall 69 of the slot 20.

Upon filling of the enlarged second chamber 30, the molding process enters what is referred to as the “pack and hold” phase of the molding cycle. During this phase, pressure is applied via the second slot 62 forcing both shots against the cavity side or A-surface side of the upper mold 16. The pressure exerted by the second shot 62 effectively seals the design line 63 against the first shot 50 against the upper mold 16 and will not allow the second shot 62 to flash to the A-surface side of the first shot 50, thus ensuring a crisp, flash-free design line 63 in the resulting component.

The second shot 62 of molten material defines a second skin portion 70 of the component 12. The second skin portion 70 may be made of any suitable material, such as thermoplastic. Because it is typically visible from the vehicle interior, the second skin portion 70 is preferably formed from a molten material having a desirable color so that painting and/or dyeing is unnecessary. It may be desirable for the colors of the respective skin portions 58, 70 to be different so that the component 12 has a two-tone appearance.

As seen in the figures, the divider 32 extends a distance substantially equal to the thickness of the first shot 50. As a result of its height, the divider 32 is able to substantially shield design line 63 of the first shot 50 from the second shot 62 of material and reduce flashing. More specifically, the divider 32 diverts the flow of the second shot 62 around the first shot 50 and onto the sloped surface 61, which presses the first shot 50 into the upper mold 16. Therefore, the diverted second shot 62 of material is more likely to flow into the enlarged second chamber 30 than to flash between the first shot 50 and the upper mold 16.

Also as a result of the height of the divider 32, the second shot 62 is formed so its A-surface has about the same “perceived” height as the A-surface of the first shot 50. The divider 32 therefore defines the joint or line between the two skin portions along the A-surface of the final component.

To maximize the beneficial forcing of the first shot 50 into the cavity surfaces of the upper mold 16, the angle of the transition surface 61 is shallow and preferably defines an angle with respect to a horizontal axis 42 (or generally the A-surface of the first shot 50) that is less than or equal to 45 degrees. Even more preferably the angle is about 25 degrees or less.

After the enlarged second chamber 30 is completely filled by the second shot 62, the first and second skin portions 58, 70 are allowed to cool, the mold is opened, and the component 12 is removed. The skin portions 58, 70 are preferably allowed to cool for a time period longer than the duration between the first and second shots so that the resultant component 12 is substantially hardened before removal. More specifically, the component 12 is preferably allowed to harden for 30 or more seconds before removal from the mold assembly 10.

As shown in FIG. 6, the first skin portion 58 defines an A-surface intersecting with the A-surface of the second skin portion 70. The first and second skin portions 58, 70 thus cooperate to define a show surface 77 exposed to the vehicle interior.

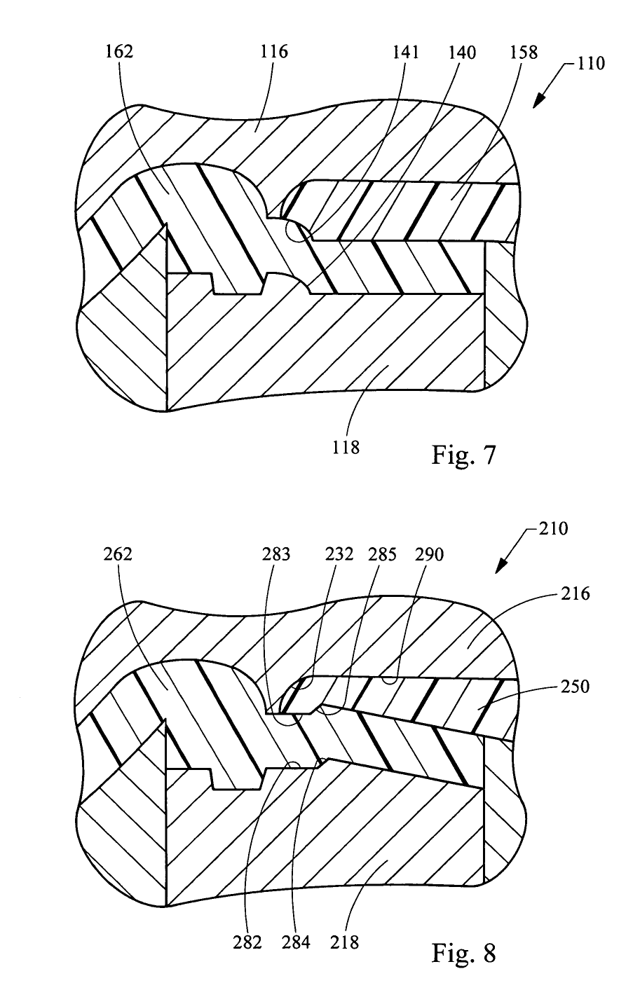

Referring now to FIG. 7, an alternative embodiment of the present invention is shown. This embodiment differs from the prior embodiment in that the mold assembly 110 has a retractable core 118 with a generally arcuate sloped portion 140 instead of a flat portion 40. As a result, the first skin portion 158 includes a generally arcuate sloped portion 141 so that the second shot 162 of material urges the first skin portion 158 toward the upper mold 116.

Referring now to FIG. 8, another alternative embodiment of the present invention is shown. In this embodiment, the mold assembly 210 has a retractable core 218 with a generally flat portion 282 and an upwardly (toward the upper mold 216) sloping portion 284. As a result, the first shot 250 includes a corresponding flat portion 283 and an upwardly sloped portion 285. This configuration causes the second shot 262 of material to flow along a horizontal axis 42 or flow path with minimal reaction forces when passing the flat portion 283 and to flow upwards (relative to the vertical axis 44) when passing the sloped portion 285. This urges orientation of the first shot 250 upwards and to the left (in FIG. 8), further promoting engagement between the first shot 250 and the upper mold 216.

It is therefore intended that the foregoing detailed description be regarded as illustrative rather than limiting, and that it be understood that it is the following claims, including all equivalents, that are intended to define the spirit and scope of this invention.

What is claimed is:

1. A mold assembly for forming a component for an interior of a vehicle, the mold assembly comprising:
a first mold half having a receiving slot;
a second mold half cooperating with the first mold half to define a mold cavity, the second mold half including a divider extending towards the receiving slot; and
a retractable core positioned within the receiving slot and being movable between a retracted position and an extended position, the retractable core and the divider engaging each other when the retractable core is in the extended position to divide the mold cavity into first and second chambers.

2. A mold assembly as in claim 1, the retractable core including:
an engagement surface configured to engage the divider when the retractable core is in the extended position; and
a sloped portion sloping away from the engagement surface in a direction away from the second mold half.

3. A mold assembly as in claim 2, wherein the sloped portion is generally planar.

4. A mold assembly as in claim 2, wherein the sloped portion is generally arcuate.

5. A mold assembly as in claim 1, the retractable core including:
an engagement surface configured to engage the divider when the retractable core is in the extended position; and
a sloped portion sloping away from the engagement surface in a direction toward the second mold half.

6. A mold assembly as in claim 1, further comprising:
a first injection assembly configured to inject a first shot of material into the first chamber of the mold cavity; and
a second injection assembly configured to inject a second shot of material into the second chamber of the mold cavity.

7. A mold assembly as in claim 6, wherein the first chamber defines a first shot thickness and the divider defines a divider height that is generally equal to the first shot thickness.

8. A mold assembly as in claim 6, wherein the first shot of material is a first color and the second shot of material is a second color.

9. A method of molding a component for an interior of a vehicle comprising:
providing a mold assembly having a first mold half, a retractable core positioned within the first mold half, and a second mold half cooperating with the first mold half to define a mold cavity;
positioning the retractable core in an extended position so as to engage a portion of the second mold half and divide the mold cavity into a first chamber and a second chamber;
injecting a first shot of material into the first chamber and forming a sloped surface adjacent to a leading edge of the first shot of material;
moving the retractable core to a retracted position to effectively enlarge the second chamber and expose the sloped surface of the first shot; and
injecting a second shot of material into the enlarged second chamber so that the second shot of material flows between the first shot of material and the retractable core and engages the slopes surface of the first shot.

10. A method as in claim 9, wherein the step of injecting the first shot of material includes injecting molten thermoplastic and wherein the step of injecting the second shot of material occurs before the molten thermoplastic of the first shot is fully hardened.

11. A method as in claim 9, wherein the step of injecting the second shot of material includes causing a leading edge of the second shot of material to engage the first shot of material and induce a force urging the first shot of material towards the second mold half to resist flashing.

12. A method as in claim 11, wherein the step of injecting the second shot of material causes the leading edge of the second shot of material to promote engagement between the first shot of material and the second mold half.

13. A component for a motor vehicle interior, the component comprising:
a first skin portion having a first skin A-surface and a first skin B-surface intersecting along a design line, the first skin B-surface defining a sloped portion located generally adjacent to the design line; and
a second skin portion bonded to the first skin B-surface so that the first and second skin portions overlap each other over the sloped portion;
wherein the first skin A-surface and a second skin A-surface cooperate to define a show surface exposed to the motor vehicle interior and cooperate to define a recessed groove along the design line.

14. A component as in claim 13, wherein the B-surface defining the sloped portion is generally planar.

15. A component as in claim 13, wherein the B-surface defining the sloped portion is generally arcuate.

16. A component as in claim 13, wherein the first and second skin portions are both thermoplastic materials.

17. A component as in claim 14, wherein the first skin portion is a first color and the second skin portion is a second color.

18. A component as in claim 14, wherein the sloped portion slopes away from the first skin A-surface.

19. A component as in claim 14, wherein the sloped portion slopes toward the first skin A-surface.
